(19) United States
(12) Patent Application Publication
(10) Pub. No.: US 2008/0275628 A1
(43) Pub. Date: Nov. 6, 2008

(54) METHOD AND APPARATUS FOR COMMUNICATING TRAFFIC INFORMATION

(75) Inventors: Xiang Xu, Nanjing (CN); Qi-Xiang Li, Nanjing (CN); Zhao-Hui Li, Nanjing (CN); Ke-Jiao Zhang, Nanjing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/743,364

(22) Filed: May 2, 2007

(51) Int. Cl. G06F 19/00; H04B 1/02

(52) U.S. Cl. 701/117; 455/91

(57) ABSTRACT

A method and apparatus for communicating traffic information, that in certain embodiments performs the actions of associating (215) with a traffic group that corresponds to a traffic region, determining (220) at least one traffic related parameter of the mobile communication device while operating within the traffic region, and transmitting (235) to the traffic group a transmit traffic information message that includes the at least one traffic related parameter. In certain embodiments, the following actions are performed: receiving (225) one or more receive traffic information messages from mobile communication devices associated with the traffic group, wherein each receive traffic information message includes at least one traffic related parameter and preparing (240) a local traffic report using the receive traffic information messages.

### FIELD OF THE INVENTION

The present invention relates generally to wireless communication systems and more specifically to communicating traffic information to communication devices used in wireless communication systems

### BACKGROUND

Motor vehicle operators often desire to know what traffic conditions exist ahead along a route that they travel. There are services in some metropolitan areas that provide some of this type of information. One example is the traffic reporters who broadcast traffic updates on AM and FM broadcast radios, based on aircraft observations and other information sources. However, these traffic reporter services are generally restricted to reporting on entire lengths of major routes or reporting on major accidents, in major metropolitan areas. Another service that is provided on some major metropolitan highways is a travel time advisory that is from one fixed point to another, which may be presented on road signs is obtained, perhaps by speed sensors at several places along the highway. This type of service is also typically restricted to major highways and long distances. A reason that such existing services tend to be limited is that providing continuous information above travel conditions for a large number of differing route segments involves a lot of information gathering and redistribution, which can require significant resources when they are centralized.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and principles of concepts that encompass the present invention.

FIG. 1 is a road map that supports a description of some aspects of the embodiments and benefits that result from some of the embodiments;

FIG. 2 is a flow chart that shows some steps of a method for communicating traffic information, in accordance with certain embodiments;

FIGS. 3 and 4 show a flow chart of some steps of a method for communicating traffic information, in accordance with certain embodiments;

FIG. 5 is a diagram that illustrates a starting position of three vehicles that are equipped with communication devices;

FIG. 6 is a legend that shows markings used in FIGS. 7-12 to indicate the speed at which a vehicle travels while going from one of the positions illustrated in FIG. 5 to another of the positions;

FIGS. 7-10 show event times for the communication devices shown in FIG. 5, and show traffic information that has been determined by each device, which in this example is the speed of travel; and

FIGS. 11-13 show functional block diagrams of communication devices in accordance with certain of the embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to traffic condition reporting. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Vehicle operators and riders want easy journeys. With more and more traffic on the roads, the vehicle operator is eager to get real-time traffic information to plan ahead and take control of the journey. The traffic information can be the traffic speed, a traffic accident, or traffic jam, etc. By knowing the real-time traffic information, the vehicle operator can find out if there will be any delays and avoid them. If the vehicle operator really cannot avoid such problems, the vehicle operator would at least like to have a more realistic idea of how long the journey will take. Here are some typical use cases:

Use Case 1: Jack is driving on IS-1 highway, he hopes to know real-time traffic information ahead on IS-1 highway.

Use Case 2: David is approaching IS-1 highway, he wishes to know real-time traffic information for IS-1 highway.

Use Case 3: Leo is leaving his office to go home. He can take either IS-1 highway, or IS-2 highway. He wants to know the traffic information on both highways, so he can make a better decision.

Use Case 4: Jane is driving on IS-2 highway. The real-time traffic information facilitates her drive smoothly along IS-2 highway. Because she plans turn right to IS-1 highway, she would like to continuously receive the real-time traffic information on IS-1 highway.

Use Case 5: Kris will go to the Woodfield mall for shopping. He is interested to know the real-time traffic information around Woodfield mall, for example, 10 miles around Woodfield mall.

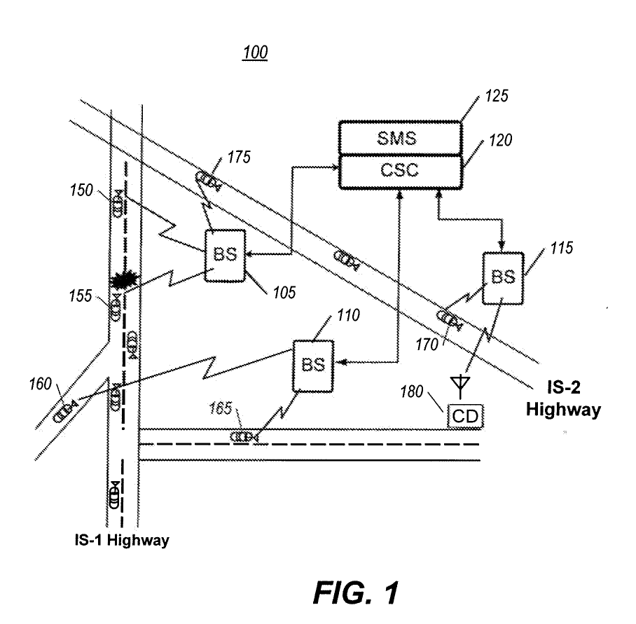

Referring to FIG. 1, a road map is shown that supports a description of some aspects of the embodiments and benefits that result from some of the embodiments. A method is performed within a cellular system 100 that includes three base stations 105, 110, 115 coupled by network links to a Cellular System Controller (CSC) 120. The cellular system can be a GSM/GPRS/EDGE system, or a UMTS system, or a CDMA2000/HRPD system, or a Ultra Mobile Broadband (UMB) system, or a TD-SCDMA system, or a IEEE802.16/WiMAX system. The cellular system 100 supports a Short Message Service (SMS) function 125 or Multimedia Message Service (MMS), or other similar service supported in existing or future cellular systems that provide a multicasting function for communication devices that are associated with one or more groups that are defined within the cellular system 100, which are identified as Traffic Groups in accordance with the embodiments described herein. In the example shown in FIG. 1, there is a plurality of vehicles 150-175, each operated by a vehicle operator. In each vehicle, there is a cellular communication device. The cellular communication device may be a permanent part of the vehicle or may be a removable cellular communication device that the vehicle operator or a passenger uses in the vehicle and elsewhere. There is also a portable cellular communication device 180 that is being carried by a person (not shown) who is walking to a car in a parking garage. Whichever of the vehicle operator, passenger, or the person who is walking who operates the cellular communication device may simply be called the user. Each of these devices 150-180 has unique functions. In the example in FIG. 1, there are two Traffic Groups, i.e. Traffic Group 1 which provides traffic information for IS-1 highway, and Traffic Group 2 which provides traffic information for IS-2 highway. Each cellular communication device may have established an association with one or both of the Traffic Groups.

User 150 and 155 are on IS-1 highway, user 160 and user 175 are approaching IS-1 highway. User 150 and 155 provide real-time traffic information to Traffic Group 1 which is then distributed to user 160 and 175.

User 175 provides traffic information to Traffic Group 2, which is then distributed to User 170.

User 165 and 180 associate to both Traffic groups in order to decide which highway has less traffic jam.

User 180 is leaving the office. He can take either IS-1 or IS-2 highway to home, but he is uncertain on the traffic condition, so he associates to Traffic Group 1 and Traffic Group 2. By knowing the real-time traffic information for both groups, he selects IS-1 which has less of a traffic jam than IS-2.

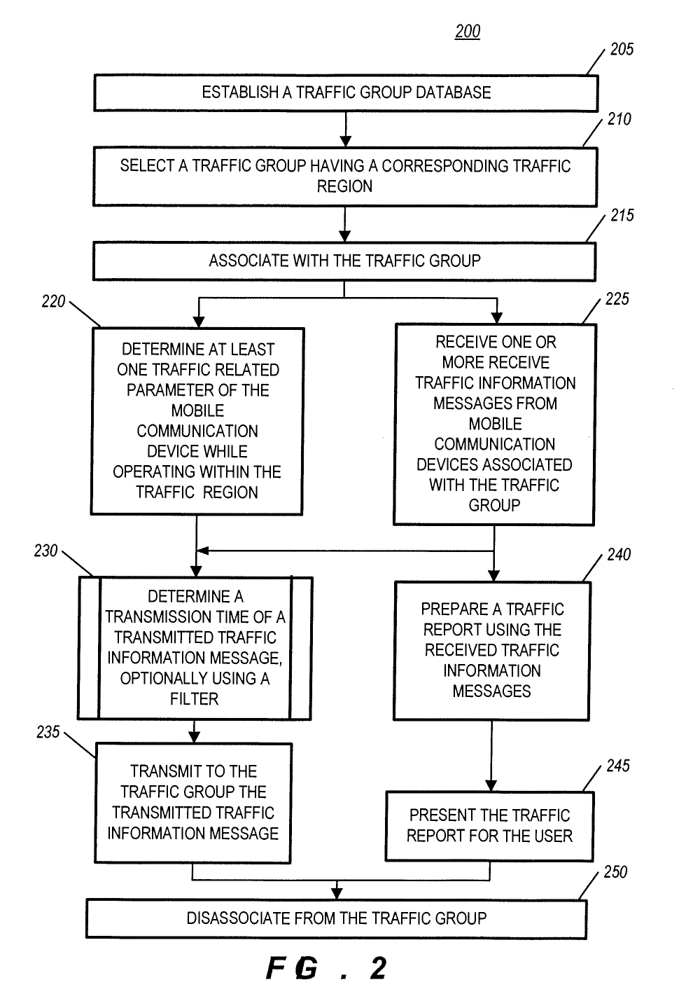

Referring now to FIG. 2, a flow chart shows some steps of a method for communicating traffic information, in accordance with certain embodiments. At step 205, a communication device, such as a cellular telephone, cellular messaging device, or vehicular cellular communication device that operates in communication with a wide area communication system, establishes a Traffic Group database. The wide area communication system may be a cellular system, but need not be—it could be, for instance, a trunking system. In some embodiments the wide area communication system has a group multicast function, allowing one transmitted message to be received by a defined group of the communication devices. The Traffic Group database may consist of a set of Traffic Group identities, a definition of a traffic region of the Traffic Group corresponding to each identified Traffic Group, and a technique for communicating traffic information to the Traffic Group. The Traffic Group identity in the communication device may be, for example, a name given to the Traffic Group by a user. The definition of the traffic region may be, for instance, in terms of geographic points and dimensions that establish any region, such as peripheral vertices of a polygon region or any other geographical shape, such as a circle or ellipse. Another example would be landmarks such as mile markers on a road. The use of geographic points may correspond to an automatic determination of a state of in-region versus out-of-region, whereas the use of landmarks may correspond to a manual determination of the in- versus out-of-region state. The technique for communicating to members of the Traffic Group may be, for example, an SMS or MMS ID for the Traffic Group, or a list of participating communication devices (as may be necessary when the wide area communication system does not provide a multicasting service). In the simplest case, only one Traffic Group may be in the database. The database may be formed in one of many ways. For example, it may be entered by a user of the communication device who obtains the information from a publication, such as a magazine or website. It may be downloaded in bulk from the communication network or a website. It may be transferred from another communication device. It may be obtained from the wide area network when the communication device gives the wide area network information to identify which group is most appropriate for the communication device to join (e.g., when the communication device provides a location of the communication device that indicates the communication device is in the region of the group).

At step 210, the communication device selects a traffic group with which to associate. This step may be accomplished in certain embodiments by the user identifying a traffic group from a list of traffic groups presented by the communication device. In some embodiments, the selection may be done substantially simultaneously with the step of establishing the traffic group database. For example, a traffic information application may be activated in the communication device while the communication device is in a region of a particular Traffic Group with a command from the user to join a Traffic Group for the region communication device is within. The communication device may receive information through the communication system that includes the previously described “database information” for the particular Traffic Group, and the communication device may then select the particular Traffic Group without user intervention and undertake the next step, step 215, to associate with the particular Traffic Group. In this sense, steps 205 and 210 may be difficult to distinguish in some embodiments. In another scenario, the communication device may present a list of previously defined Traffic Groups to the user, who may select one of them (step 210)—either while the communication device is within or without the region of the selected Traffic Group. In this instance, the communication device may use location information available to the communication device to wait until it is within the region of the selected Traffic Group, and then may associate itself (step 215) with the Traffic Group, by sending a registration or subscription message to the communication system 100 that asks permission to be an active member of the Traffic Group. However, associating may not require permission of the communication system 100 in all embodiments, and may be effectively accomplished when selection (step 210) of the Traffic Group is made. Thus, steps 210 and 215 may difficult to distinguish in some embodiments; in those embodiments the user may select and associate with a Traffic Group at step 210 and the next step may effectively be either step 220 or step 225 of FIG. 2.

Once associated with a Traffic Group, the method may continue with step 220 or step 225. In some embodiments (those operating in a “receive only” mode), steps 220, 230, and 235 are not performed. In other embodiments, (those operating in a “transmit only” mode), steps 225, 240, and 245 are not performed. In some embodiments, either step 220 or 225 may be performed next. In these embodiments, the timing of the execution of steps 220, 230, and 235 is substantially independent of the execution of steps 225, 240, and 245.

Step 220 includes the determination of at least one traffic related parameter of the communication device while associated with the traffic group and operating within the traffic region. The at least one traffic related parameter may be one of a group that includes, but is not limited to, an average speed during a first duration, a high speed during a second duration, a low speed during third duration, an acceleration during a fourth duration, a significant local road condition, and a time of measurement of one or more of these other parameters. The speeds, acceleration, and time may be determined automatically, or, in some embodiments, may be user estimates. Significant local road conditions would more typically be user inputs, such as a new traffic accident (i.e., one that is slowing traffic substantially and for which no public safety personnel have arrived on the scene), or a new major obstacle in the road (such as material that has fallen off a vehicle), although as vehicular sensing systems improve, some of these things may become more automated (i.e., a vehicle in a recent accident may be transmitting a signal that can be locally sensed). The first, second, third, and fourth durations may be related. For example, the second and third durations may be equal to the first duration, and the high and low speeds are “instantaneous” extremes, or the second and third durations are very short durations within the first duration over which the highest and lowest speeds are determined by averaging.

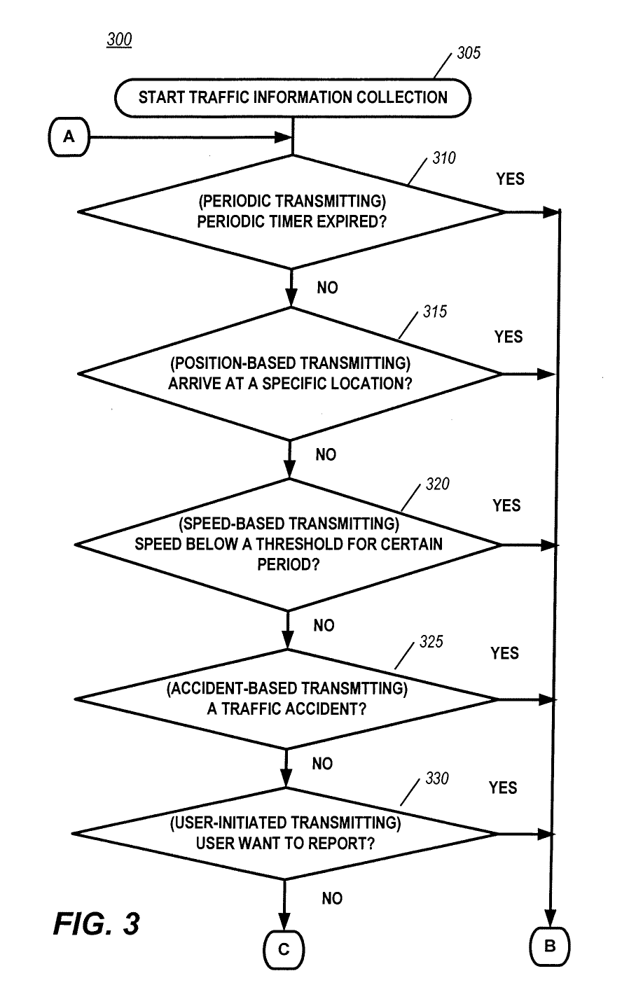

At step 230, the communication device determines a time of transmission of a transmit traffic information message. This step may be considered to be skipped in certain embodiments. In these embodiments, the communication device may simply transmit the transmit traffic information message (step 235) as soon as a traffic parameter is determined. For example, a new traffic accident may be transmitted as soon as a user enters the information about it. In another example, an average speed may be determined at a fixed rate and transmitted at that rate. In certain embodiments, the determination may be done according to a set of criterion. In certain embodiments, the determination may include using a filter. These latter aspects are described in more detail below, with reference to FIG. 3.

At step 235, the communication device transmits a transmit traffic information message that includes the at least one traffic related parameter. The transmission is “to the traffic group”. In systems that support group multicasting, the message may be effectively addressed directly to the group, although it is of course processed by network equipment of the communication system, and the network typically reformulates it for transmission as a multicast message. In other systems, the traffic information message may include a plurality of addresses of other communication devices that are presumed active in the traffic group, which the network may then reformulate into a plurality of individual messages that are transmitted separately to each active communication device, each of which contains the traffic information. In yet another embodiment, the communication device identifies the traffic group within the information message and the network equipment correlates that to a list of individual addresses of communication devices that are presumed active in the traffic group, and transmits an individual message for each address.

At step 225, the communication device receives one or more receive traffic information messages from communication devices associated with the traffic group. The traffic information messages include at least one traffic parameter determined by at least one other communication device associated with the traffic group. At step 240, the communication device prepares a report based on traffic related parameters received in the one more receive traffic information messages. This report may be one of a number of types. It may be a report that is prepared periodically, that shows only new information obtained within the period, or one that performs a rolling average for at least some of the information in the report, using information from a previous period or periods. The report may be generated upon an event, such as information concerning a new road condition or traffic accident. The report may categorize information by sub regions, when location information is received in a sufficient number of receive traffic messages.

The report is presented to the user by the communication device at step 245. This presentation may be made, for example, upon request of the user, or it may be an update to a report that is continuously displayed, or it may be a report that is presented periodically, or it may be a report that is presented upon an event related to the traffic related parameters, such as an apparently new road condition. Such new road conditions may be filtered in the step of preparation 240, by storing received parameters and discounting similar condition reports that meet certain parameters (e.g., difference of reported location).

At step 250, the communication device disassociates itself from the Traffic Group, ceasing to transmit the transmit traffic messages and ceasing to use receive traffic messages for report generation. Such disassociation may occur in response to moving out of a traffic region or a user command.

Referring now to FIGS. 3 and 4 a flow chart 300 shows some steps of a method for communicating traffic information, in accordance with certain embodiments. In particular the steps of FIGS. 3 and 4 are closely related to step 230 of FIG. 2, the step in which a time of transmission of a transmit traffic message is determined. At step 305, traffic information collection is started. This is substantially equivalent to step 220 of FIG. 2. At step 310, a determination may be as to whether a periodic timer has expired. When the timer has expired, the method continues at step 405 (FIG. 4). When the timer has not expired, the method continues at step 315, at which step a determination may be as to whether a specified location has been reached. When the specified location has been reached, the method continues at step 405 (FIG. 4). When the specified location has not been reached, the method continues at step 320, at which step a determination may be as to whether an average speed has gone below a threshold for a specified time period. When the average speed has gone below a threshold for a specified time period, the method continues at step 405 (FIG. 4). When the average speed has not gone below a threshold for a specified time period, the method continues at step 325, at which step a determination may be as to whether a traffic accident has been observed. When a traffic accident has been observed, the method continues at step 405 (FIG. 4). When a traffic accident has not been observed, the method continues at step 330, at which step a determination may be as to whether a user has indicated a desire to report traffic conditions. When a desire to report traffic conditions has been indicated, the method continues at step 405 (FIG. 4). When a desire to report traffic conditions has not been indicated, the method continues at step 425 (FIG. 4). An optional criteria that is not shown in FIG. 4 is that the average speed has gone above a threshold for a specified time period.

It will be appreciated that one of the criteria of steps 310 to 330 has been met when step 420 is executed. At step 405, a determination may then be made as to whether filtering criteria have been met. The filtering criteria are typically established so as to determine whether traffic related parameters gathered at step 220 are similar to those that have been received in a receive traffic message, as indicated by the link from step 225 to step 230 in FIG. 2. Filtering criteria may include one or more of:

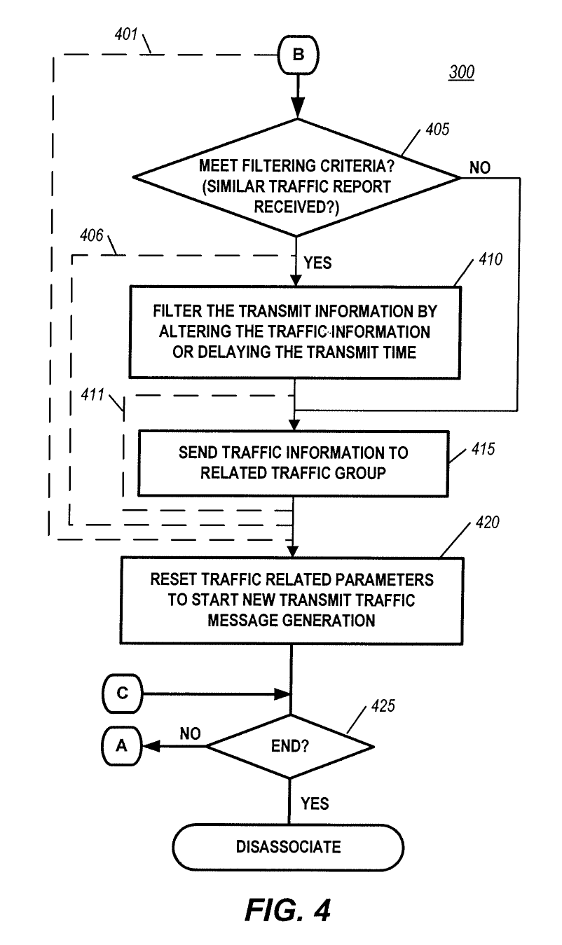

1) a comparison of speed information in the one or more transmit or receive traffic information messages and a recent speed of the mobile communication device (examples of this are given below, with reference to FIGS. 5-10);

2) intervals of receipts of one or more recent receive traffic information messages passing a high or low threshold count (i.e., avoiding an over-saturation condition of the radio channels);

3) new local road condition severity passing a high or low threshold (e.g., a bad accident warrants a rapid transmission);

4) distances between the mobile communication device and mobile communication devices generating the one or more receive traffic information messages passing a high or low threshold (e.g., short distances may be used to increase the interval).

When the filtering criteria have not been met, a transmit traffic information message is transmitted at step 415, which is substantially equivalent to step 235 (FIG. 2). The transmit traffic information message contains traffic related parameters that have been determined in step 220. When the filtering criteria have been met at step 405, the transmit traffic information message is filtered at step 410, which may involve either delaying the time of transmission of the transmit traffic information message or altering the contents of the transmit traffic message information to remove information that has recently been transmitted by other communication devices, or both. When the filter action has been taken, the transmit traffic information message is transmitted at step 415, either after a delay or with altered traffic related parameters, or both. Then traffic related parameters are reset at step 420, so as to start gathering traffic related parameters for a new transmit traffic message. In some instances, delaying the transmit time at step 410 may result in simply cancelling the transmission, in which case step 415 is skipped, as indicated by path 411. Resetting the traffic related parameters may include such things as discarding previously determined maximum and minimum speeds and starting an average speed determination over again, discarding a determined location, discarding an accident observation, and resetting a state of a detected user input from an indication of a desire to transmit a report of traffic related parameters to no indication of desire to transmit a report of traffic related parameters. The filter decision (step 405) uniquely prevents excessive transmissions of redundant information. In some embodiments, filtering may not be used at all, as indicted by path 401, and in some embodiments, filtering may consist of always cancelling the transmission, as indicated by path 406.

After the traffic related parameters are reset at step 420, the decision step 425 determines whether any criteria (discussed above with reference to step 250 (FIG. 2)) has been met that would cause disassociation from the traffic group. If a criterion for disassociation has been met, the method ends. If no criterion for disassociation has been met, the method continues at step 310. It should be appreciated that not all of the steps described need be in all embodiments, nor need they all be executed in the order described. For example, the execution of some steps such as may be a user selectable or system controllable option.

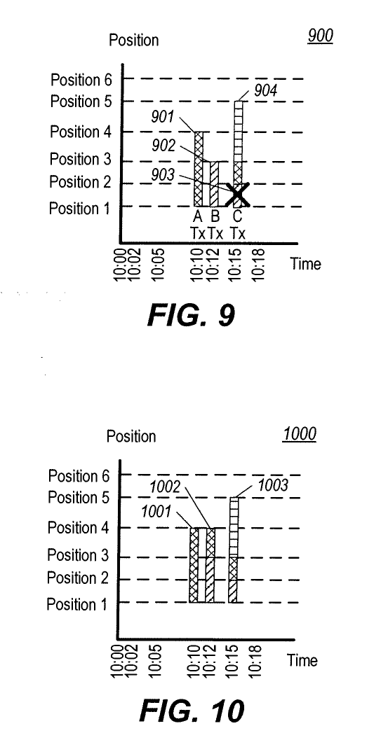

Referring now to FIG. 5, a diagram 500 illustrates a starting position of three vehicles that are equipped with communication devices on road IS-1, marked position 1. Other positions along the road are also identified. These positions are used in FIGS. 7-12 to support descriptions of types of filtering actions.

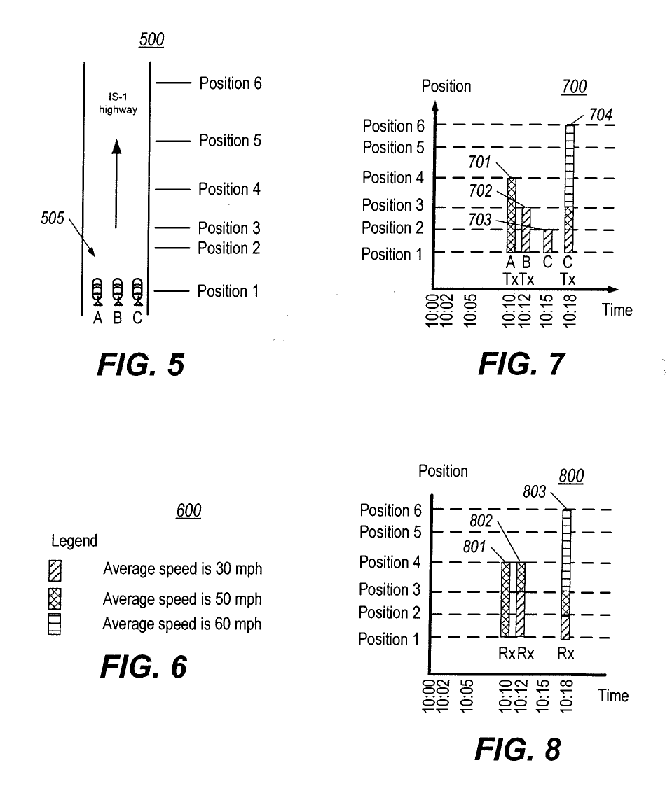

Referring to FIG. 6, a legend 600 shows markings used in FIGS. 7-12 to indicate the speed at which a vehicle travels while going from one of the positions illustrated in FIG. 5 to another of the positions. For the examples described with reference to FIGS. 7-12, the following initial facts are assumed:
Communication devices A, B, and C are in traffic group 1 and leave position 1 at 10:00, 10:02, and 10:05, respectively.
The communication devices A, B, and C have a normal traffic message transmission interval of 10-minute. So the next normal transmission times for mobile devices A, B, and C are 10:10, 10:12, and 10:15, respectively.
Communication device D is not on IS-1 highway, but is associated with traffic group 1, and will receive traffic information from communication devices in traffic group 1 that transmit them. Communication device D does not transmit any traffic information message.
At 10:10, device A transmits a traffic information message, which is then received by other mobile devices (for example, B, C, and D).

Referring now to FIGS. 7-8, diagrams 700, 800 show event times for the communication devices 505 shown in FIG. 5, and traffic information that has been determined by each device, which in this example is the speed of travel.

Referring to FIG. 7, the traffic information 701 transmitted by device A at 10:10 indicates that it was traveling 50 mph between positions 1 and 4. The normal time for device B to transmit its traffic information message is 10:12. The traffic information 702 determined by device B is quite different from the traffic information 701 received by B from A at 10:10. So device B transmits the traffic information 702 which is then received by other mobile devices in traffic group 1 (for example, devices A, C and D). Upon receipt of the traffic information 702 by device C from device B, device C finds that the traffic information 703 that it has determined between position 1 and 2 is the same as the one transmitted by device B. Device C therefore delays the normal traffic information transmission by 3-minutes (It takes 3-minute for Device C from position 1 to position 2). So device C adjusts its transmission time from 10:15 to 10:18 (a 3-minute delay). At 10:18, device C transmits its own determined traffic information. The traffic information is received by other mobile device (for example, device D)

FIG. 8 shows the how the traffic information received at device D is used to generate the traffic report for the user of device D. At 10:10, device D receives the traffic information from device A that covers region from position 1 to position 4. The average speed of device A is 50 MPH between position 1 and position 4, so device D updates its traffic information report 801 to show an average speed of 50 mph between points 1 and 4. At 10:12, device D receives the traffic information from device B that covers region from position 1 to position 3. So it updates its traffic information report 802 by changing the average speed between position 1 and position 3 to 30 MPH. At 10:18, device D receives the traffic information from device C that covers region from position 1 to position 6. Device D updates its traffic report 803 by changing it to show an average speed between position 2 and position 3 of 50 MPH, changing it to show an average speed of 60 mph between positions 3 and 6, and keeping 30 MPH as the average speed between position 1 and position 2.

Referring now to FIGS. 9-10, diagrams 900, 1000 show event times for the communication devices 505 shown in FIG. 5, and traffic information that has been determined by each device, which in this example is the speed of travel, using the same set of starting conditions as in FIGS. 7 and 8. These diagrams also support a description of a filtering technique that does an effective job of reducing the transmission of redundant traffic information in certain embodiments of the traffic information communication systems, while not unduly eliminating new information as it becomes available.

Referring to FIG. 9, the traffic information 901 transmitted by device A at 10:10 indicates that it was traveling 50 mph between positions 1 and 4. The normal time for device B to transmit its traffic information message is 10:12. The traffic information 902 determined by device B is quite different from the traffic information 901 received from A at 10:10. So device B transmits the traffic information 902 which is then received by other mobile devices in traffic group 1 (for example, devices A, C and D). Upon receipt of the traffic information 902 by device C from device B, device C finds that the traffic information 903 that it determined between position 1 and 2 is the same as the one transmitted by device B. Device C transmits its traffic information at the normal time of 10:15, but excludes the traffic information 903 that it had determined between positions 1 and 2. The traffic information is received by other mobile device (for example, device D).

FIG. 10 shows the how the traffic information received at device D is used to generate the traffic report for the user of device D. At 10:10, device D receives the traffic information from device A that covers region from position 1 to position 4. The average speed of device A is 50 MPH between position 1 and position 4, so device D updates its traffic information report 1001 to show an average speed of 50 mph between points 1 and 4. At 10:12, device D receives the traffic information from device B that covers region from position 1 to position 3. So it updates its traffic information report 1002 by changing the average speed between position 1 and position 3 to 30 MPH. At 10:15, device D receives the traffic information from device C that covers region from position 2 to position 6. Device D updates its traffic report 1003 by changing it to show an average speed between position 2 and position 3 of 50 MPH, changing it to show an average speed of 60 mph between positions 3 and 6, and keeping 30 MPH as the average speed between position 1 and position 2.

It will be appreciated that the descriptions relative to FIGS. 7-8 show how the transmission time may be delayed, and the descriptions relative to FIGS. 9-10 show how the traffic related parameters may be reduced, each technique doing an effective job of reducing the transmission of redundant traffic information in the traffic information communication systems, while not unduly eliminating new information as it becomes available. It will also be appreciated that these techniques may be combined in some embodiments.

The communication device can also use other filtering techniques to minimize sending duplicated traffic information messages. For example, when the device determines that there is no change to any traffic related parameters that it has most recently sent, then the device can wait for a next transmission interval. For example, when device A sends a traffic information message that reports a full stop due to an accident, the device may stop sending any traffic information until the device begins moving, or some other traffic related parameter changes, or the device receives an explicit query from another mobile device to transmit a traffic information message. In yet other circumstances, it may be that the interval for transmission times is reduced rather than increased. This, for example, may be done when the number of reporting communications devices is low.

From these descriptions, certain filtering methods may be more generally stated as methods in which a transmission time of the transmitting of the transmit traffic information message and/or an information content of the transmit traffic information message is determined by an filtering function that is a function of at least one of 1) times of transmissions of one or more previous transmit traffic information messages transmitted by the mobile communication device and 2) traffic information within the one or more previous transmit traffic information messages transmitted by the mobile communication device. Similarly, the filtering function may further be a function of at least one of 1) times of receipts of the one or more receive traffic information messages and 2) traffic information within the one or more receive traffic information messages.

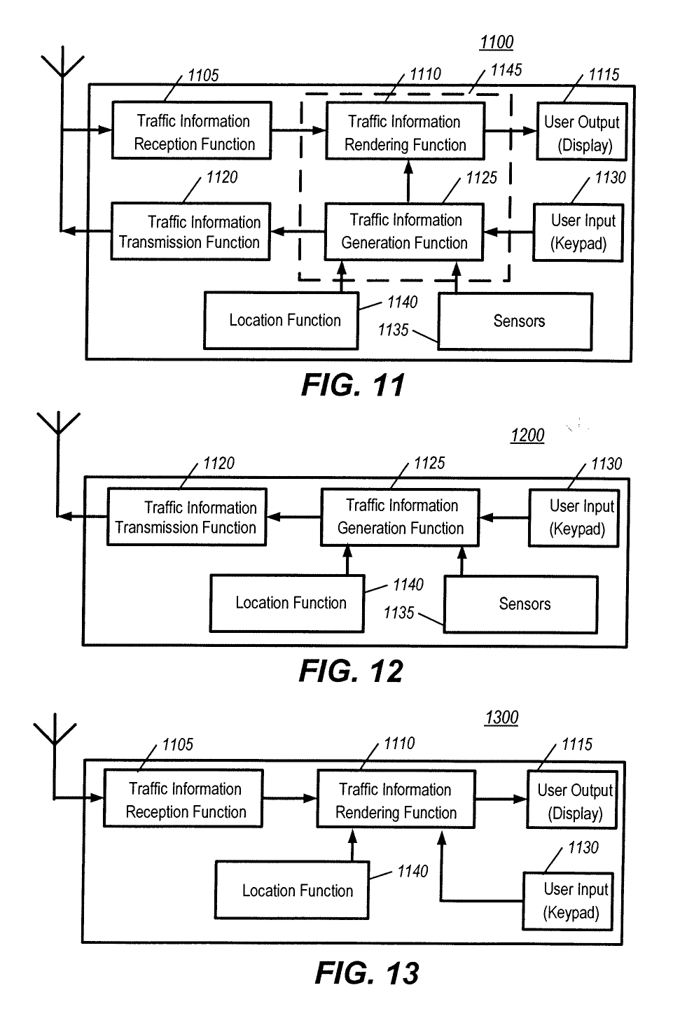

Referring to FIG. 11, a functional block diagram shows a communication device 1100 in accordance with certain of the embodiments. The communication device 1100 comprises a traffic information reception function 1105 that receives a radio signal, from which the traffic information reception function 1105 derives information that is coupled to a traffic information rendering function 1110. The communication device 1100 further comprises a traffic information generation function 1125 that is coupled to one or more user input modalities 1130, exemplified by a keypad in FIG. 11, as well as one or more sensors 1135 and an optional location system 1140. The traffic information generation function 1125 uses information from the sensors 1135, the location system 1140, and from the user input modalities 1130 to determine the traffic related parameters, and to perform filtering, as described with reference to FIGS. 1-10. The currently determined traffic related parameters are coupled to the traffic information rendering function 1110 which merges them with traffic information received by the traffic information reception function 1105 and prepares a report for presentation on one or more user output modalities 1115, such as the display shown in FIG. 11. The traffic related parameters are also transmitted to a traffic groups by a traffic information transmission function 1120.

The traffic information reception function 1105 and traffic information transmission function 1120 may be a conventional radio transceiver, or a conventional radio receiver and a conventional radio transmitter (or newly invented one(s) providing similar functions). The one or more user input modalities 1130, the one or more sensors 1135 the optional location system 1140, and the one or more user output modalities 1115 may be conventional functions and hardware (or newly invented one(s) providing similar functions). The location function may be of one or more conventional location technologies that are used to obtain a current location (or a newly invented one providing similar functions). These technologies include (but are not limited to) GPS, U-TDOA, IPDL-OTD (Idle Period DownLink Observed Time Difference of Arrival), E-OTD (Enhanced Observed Time Difference), U-TDOA (Uplink Time Difference of Arrival), WiFi-RTLS (Real Time Location Tracking), Network Assisted Global Navigation Satellite System (e.g. Network Assisted GPS or Network Assisted GALILEO) and methods using cell site or sector information and Timing Advance or RoundTrip Time measurements.

The traffic information rendering function 1110 and the traffic information generation function 1125 may be embodied in a unique set of programming instructions organized to provide the functions largely described with reference to FIGS. 1-10, when used to control a processing system 1145. As such, the communication device may comprise a memory for storing the programming instructions and a processing system hardware (not shown in FIG. 11). The memory may also store the traffic group database.

Referring to FIG. 12, a functional block diagram shows a communication device 1200 in accordance with certain embodiments. The communication device 1200 is basically a stripped down version of the communication device 1100, which has had the traffic information reception function 1105 and traffic information rendering function 1110 removed, making it basically a one way device for the purpose of traffic information transmission to other members of a traffic group. This embodiment could be useful as a lower cost, transmission only device—which could, for example, be placed in a commuter train that follows a highway, from which the train operator could manually report accidents.

Referring to FIG. 13, a functional block diagram shows a communication device 1300 in accordance with certain embodiments. The communication device 1300 is basically a stripped down version of the communication device 1100, which has had the traffic information generation function 1125 and traffic information transmission function 1120 removed, making it a one way device for the purpose of traffic information reception from other members of a traffic group. This embodiment could be useful as a lower cost, reception only device—which could, for example, be used on an alternative means of transportation such as a bicycle, for which a user may be interested in traffic conditions but whose traffic related parameter would not be of interest to other members of the traffic group.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique sets of stored program instructions that control the one or more processors to implement, in conjunction with certain non-processor circuits, some, most, or all of the functions of {replace with a technical description of the invention in a few words} described herein. The non-processor circuits may include, but are not limited to, a radio receiver, a radio transmitter, signal drivers, clock circuits, power source circuits, and user input devices. As such, these functions may be interpreted as steps of a method to perform {replace with a technical description of the invention in a few words}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method used in a mobile communication device for communicating traffic information, comprising:
associating with a traffic group that corresponds to a traffic region;
determining at least one traffic related parameter of the mobile communication device while operating within the traffic region; and
transmitting to the traffic group a transmit traffic information message that includes the at least one traffic related parameter.

2. The method according to claim 1, further comprising selecting the traffic group from a traffic group database.

3. The method according to claim 1, wherein the at least one traffic parameter is transmitted when a criteria is met, wherein the criteria is one of a group that consists of expiration of an interval, reaching a specific location, below a speed for a period, above a speed for a period, and finding a road condition.

4. The method according to claim 1, wherein the at least one traffic parameter includes at least one of a location of the mobile communication device, an average speed of the mobile communication device, a maximum speed of the mobile communication device, a minimum speed of the mobile communication device, an average acceleration of the mobile communication device, a time related to the at least one traffic parameter, and a new local road condition.

5. The method according to claim 1, wherein at least one of a transmission time of the transmitting of the transmit traffic information message and content of the transmit traffic information message is determined by an filtering function that is a function of at least one of 1) times of transmissions of one or more previous transmit traffic information messages transmitted by the mobile communication device and 2) traffic information within the one or more previous transmit traffic information messages transmitted by the mobile communication device.

6. The method according to claim 5, further comprising receiving one or more receive traffic information messages from one or more mobile communication devices associated with the traffic group, wherein the filtering function of the traffic information associated with the mobile communication device is further a function of at least one of 1) times of receipts of the one or more receive traffic information messages and 2) traffic information within the one or more receive traffic information messages.

7. The method according to claim 6, wherein the filtering function alters an interval between the transmission of the transmit traffic information message and a most recent transmit traffic information message in response to at least one of the following:
comparison of speed information in the one or more transmit or receive traffic information messages and a recent speed of the mobile communication device;
intervals of receipts of one or more recent receive traffic information messages;
new local road condition severity;
distances between the mobile communication device and mobile communication devices generating the one or more receive traffic information messages.

8. The method according to claim 6, wherein the filtering function reduces traffic related parameter information in response to at least one of the following:
comparison of speed information in the one or more transmit or receive traffic information messages and a recent speed of the mobile communication device;
intervals of receipts of one or more recent receive traffic information messages;
new local road condition severity;
distances between the mobile communication device and mobile communication devices generating the one or more receive traffic information messages.

9. The method according to claim 1, further comprising:
receiving one or more receive traffic information messages from mobile communication devices associated with the traffic group, wherein each receive traffic information message includes at least one traffic related parameter; and
preparing a local traffic report using the receive traffic information messages

10. A method used in a mobile communication device for communicating traffic information, comprising:
associating with a traffic group that corresponds to a traffic region;
receiving one or more receive traffic information messages from mobile communication devices associated with the traffic group, wherein each receive traffic information message includes at least one traffic related parameter; and
preparing a local traffic report using the receive traffic information messages

11. The method according to claim 10, further comprising:
presenting the local traffic report on a human output modality.

12. The method according to claim 10, wherein the traffic report includes at least one of 1) a location of the mobile communication device, 2) an average travel time within the traffic region and 3) a new local road condition.

13. A communication device, comprising:
a transmitter;
a processing system controlled by programmed instructions that executes a traffic information generation function that operates in conjunction with the transmitter to associate the communication device with a traffic group that corresponds to a traffic region;
wherein the traffic information generation function determines at least one traffic related parameter of the mobile communication device while operating within the traffic region; and
wherein the traffic information generation function operates in conjunction with the transmitter to transmit to the traffic group a transmit traffic information message that includes the at least one traffic related parameter.

14. The communication device according to claim 13, further comprising a memory coupled to the processing system that stores a traffic group database from which the traffic group may be selected.

15. The communication device according to claim 13, further comprising one or more sensors whose outputs are coupled to the processing system, wherein the at least one traffic parameter is derived from one or more of the sensor outputs and includes at least one of a location of the mobile communication device, an average speed of the mobile communication device, a maximum speed of the mobile communication device, a minimum speed of the mobile communication device, an average acceleration of the mobile communication device, a time related to the at least one traffic parameter, and a new local road condition.

16. The communication device according to claim 13, further comprising
a radio receiver coupled to the processing system that receives one or more receive traffic information messages from mobile communication devices associated with the traffic group, wherein each receive traffic information message includes at least one traffic related parameter; and
a traffic information rendering function executed by the processing system that prepares a local traffic report using the receive traffic information messages.
